(19) United States
(12) Patent Application Publication
(10) Pub. No.: US 2006/0125229 A1
(43) Pub. Date: Jun. 15, 2006

(54) Easel pad

(76) Inventor: Gustav Allen Ray, Pacifica, CA (US)

Correspondence Address: Gustav Allen Ray, 36019 Pansy Road, Winchester, CA, 92596, US

(21) Appl. No.: 11/009,908

(22) Filed: Dec. 13, 2004

(51) Int. Cl. B42D 1/00

(52) U.S. Cl. 281/15.1; 428/43

(57) ABSTRACT

A stack of sheets bound on one end and supported by a backing sheet with dimensions of at least 25.5 by 33 inches. Individual sheets are removed from the bound stack of sheets with a horizontal microperfed line. Further, each sheet can be divided into nine 8.5 by 11 inch subsections using lines of weakening within the paper sheet whereby each 8.5 by 11 inch subsection can be easily folded or loaded into a copier, printer, scanner or shredder.

### BACKGROUND OF THE INVENTION

Conventional flip charts or easel pads typically have a plurality of stacked sheets attached together along the top edge by staples or hot melt glue to secure the sheets to one another along the top margin and to a supportive backing sheet. Further the sheets typically have a line of weakening such as a microperfed line on the top of the sheet to enable removal of a single sheet from the easel pad. Pads containing sheets of this type are in common use, as for example, for note taking, brainstorming and presentations. These pads have enjoyed widespread use and are typically available in a 27 inch wide by 34 inches high in size.

As a result of the easel pad's typical large form factor it is very difficult and time consuming to store, show or distributed to others. The cumbersome methods currently available for transcribing or digitizing a easel pad page to show others are: The image may be transcribed or manually written down or typed into a computer and then reproduced and transmitted electronically, or use an expensive electronic whiteboard or a similar device in place of a easel pad which is limited to the type of markers and its portability, or use a an expensive high-resolution digital camera to take a digital picture of the original image.

In order to overcome the storage, distribution and recognition difficulties of the easel pad form factor, the present invention provides a plurality microperfed lines to divide the easel pad into a nine of 8.5 by 11 inch subsections in order to easily fold the easel pad page into a convenient 8.5 by 11 inch form factor, or to scan each subsection in a desktop scanner or to destroy it by feeding the subsections into a shredder.

However, if there isn't a shredder or trashcan available and one wants to just write temporary information that will not be stored there has not been a solution. The present invention solves this problem of temporarily writing information by providing a plastic sheet for erasably writing over the surface of the easel pad paper with erasable markers. The plastic sheet is attached to the top of the backing sheet with an adhesive and folds over the front the easel pad when in use.

Regardless of whether the data on the easel pad is disposable or worth saving it often involves placing stickers on it to organize, rank or mark the written information. As a result it requires one to bring sheets of stickers with them or to have a stack of stickers nearby. The present invention solves this problem by attaching a sheet of stickers to the easel pad. The individual stickers can be preprinted or designed and printed with any commercially available software such as Microsoft Word or WordPerfect. Individually printed stickers can then be attached to the easel pad pages to help identify, mark, rank or clarify material written on the easel pads. Or the individual die cut stickers can also be used for adhering individual easel pad sheets onto a wall or surface, which is much easier than trying to find a roll of tape and tear off individual adhesive strips.

In addition, current easel pads are best suited for writing on them when the easel pad is placed on an easel. Mounting a easel pad on a wall is another option. However, it requires a user to tear off every sheet after they are done writing on it since it is impossible to flip the easel pad sheet over and start writing on a new sheet since the easel pad is attached to the wall or substrate. The present invention solves this by allowing the easel pad sheets to flip down by binding the bottom edge as well as the top edge. After writing on the easel pad sheet one can simply release the top bound edge and the sheet hangs down by the bound bottom edge exposing a clean easel pad sheet for writing on.

These and other objects of the invention will be apparent to those skilled in this art from the following detailed description of a preferred embodiment of the invention.

### BRIEF SUMMARY OF THE INVENTION

The present invention is a easel pad sheet designed to be easily fed into a sheet fed machine such as a scanner, fax machine, printer, copier or shredder. By making the easel pad sheet's writable surface have dimensions of at least 25.5 inches wide and 33 inches long each easel pad sheet can be easily divided into nine 8.5 by 11 inch subsections by lines of weakening such as microperf lines, score lines or partial diecuts. Then by removing the easel pad sheet and separating out the individual 8.5 by 11 inch subsections one can easily load the sheets into a sheet fed machine. For example, a scanner scans each subsection, so that a computer program can take each subsection and reassemble the subsections back into a composite image for viewing and manipulation on a computer, or the individual subsections can be loaded into a personal shredder for destruction, or the individual subsections can be loaded into a personal copier for copying, or the individual subsections can be stored in a 3-ring binder or the like or the individual subsections can be faxed to another fax machine. Each subsection may also have indicia or markings on each subsection so that a software program can easily recognize, distinguish and reassemble the individual subsections back into an original assembled image.

In an alternative embodiment of the invention the easel pad sheet contains score lines to facilitate folding each individual sheet into a convenient size. For example, after one is done writing on a easel pad page the page can be removed and easily folded into an 8.5 by 11 inch folded product by folding along the score lines which divide the easel pad sheet into nine 8.5 by 11 inch sections.

In an alternative embodiment of the invention a sheet of labels is bound into the easel pad between the backing sheet and the last easel pad sheet. The sheet of labels is divided into nine subsections by lines of weakening such that each subsection may be removed and fed into a desktop printer for imaging. Further, the sheet of labels subsections contain a series of diecuts defining individual stickers. The stickers can then be used to adhere the easel pad sheets to a substrate or the stickers may be used to call out or mark images or writings on the easel pad sheet. Nonlimiting examples of individual stickers shapes are stars, circles and squares. In addition, the stickers can have written indicia on them such as, “confidential”, “old” and “new”.

In an alternative embodiment of the invention a plastic sheet is attached to the bound end of the easel pad. The plastic sheet serves as an erasable writing surface for temporarily writing information, data and drawings. The plastic sheet is bound on one end to the easel pad such that the plastic sheet and can be flipped over and overlay the top sheet on the easel pad for use as an erasable surface. Further, the plastic sheet may contain surface coatings to cause even common permanent markers to become erasable.

In another alternative embodiment the invention has both the top and bottom edge of the easel pad sheets bound. Thus, one can mount the easel pad on a wall and release the top bound edge after writing on the easel pad sheet and it remains bound and hanging vertically under the easel pad exposing a clean new easel pad sheet for writing on. If desired, one can then release the entire sheet from the easel pad by releasing the bottom bound edge of the easel pad sheet. In addition, the easel pad sheet may contain lines of weakening to allow easel pad sheets to be flipped behind the easel pad by removing the easel pad from the wall attachments used to secure the easel pad by the apertures located in the top bound end. The lines of weakening then allow the easel pad sheet that is flipped over and on the back of the easel pad to be penetrated by the wall attachments and allow the wall attachments to then penetrate the apertures in the top bound end of the easel pad securing the easel pad to the wall or substrate.

In an alternative embodiment the easel pad has a writing instrument holder attached to the bound end of the easel pad. The holder can be made of plastic and attached to the bound end with adhesive.

### BRIEF DESCRIPTION OF THE DRAWINGS

FIG. 1 is a perspective view of a easel pad with lines of weakening and indicia.

FIG. 2 is a perspective view of a easel pad and an erasable plastic surface with writing on the erasable surface.

FIG. 3 is an elevated view of a single easel pad sheet with lines of weakening and indicia.

FIG. 4 is an elevated view of a single easel pad sheet divided into 9 subsections along lines of weakening.

FIG. 5 is a perspective view of a document scanner and one of the 9 subsections loaded into the scanner for scanning.

FIG. 6 isperspective view of a computer running a software program that is displaying the 9 subsections assembled by a computer program into a single composite digital image.

FIG. 7 is a perspective view of a folding sheet of labels attached to a easel pad.

FIG. 8 is a perspective view of a writing instrument holder attached to the bound end of a easel pad.

FIG. 9 is an elevated view of a easel pad bound on the top and bottom end and lines of weakening separating each easel pad sheet from the bound ends.

FIG. 10 is an elevated view of a easel pad with lines of weakening locatedon the easel pad sheets in alignment with the aperature opening on the back of the easel pad in the top bound end when the easel pad sheet is flipped over the top of the easel pad.

FIG. 11 is a perspective view of a easel pad bound on the top and bottom end with a easel pad sheet released from only the top bound end and thus hanging down exposing a new easel pad sheet.

FIG. 12 is a cross section view of a easel pad mounted to substrate by a hook. The easel pad shows a easel pad sheet released from the top bound edge hanging vertically and secured by the bottom bound edge.

FIG. 13 is a cross secfion view of a easel pad mounted to a sustrate by a hook. The easel pad has a easel pad sheet flipped over the top. The hooks penetrate through the flipped over easel pad sheet lines of weakening and through the aperture located in the top bound edge of the easel pad securing the easel pad to the substrate.

### DETAILED DESCRIPTION

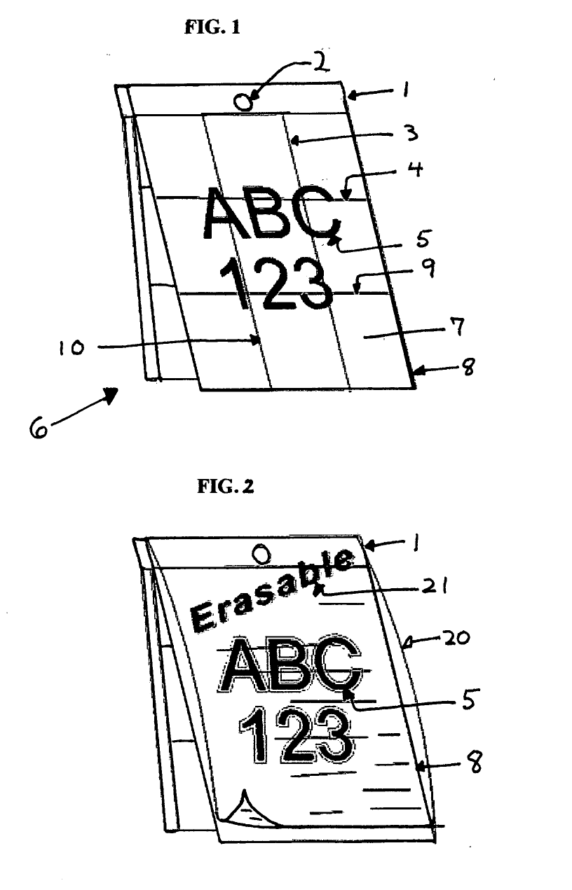

In the preferred embodiment shown in FIG. 1 a easel pad 6 contains a bound end 1 which is three inches tall by 23.5 inches wide in which five to one hundred of the 23.5 by 33 inch 24 pound paper easel pad sheets 8 are removably attached by staples to a ⅛ inch thick cardboard backing sheet. Further the easel pad sheets 8 can be a pressure sensitive adhesive construction with a facestock, adhesive layer and release liner or a the easel pad sheets can be plastic sheets. Other nonlimiting examples of binding the sheets to a backing sheet and together are glue, rivets, tape and clips. The aperture 2 is preferably 1-2 inches in diameter and located in the center of the bound end 1. Each easel pad sheet 8 is divided into nine 8.5 by 11 inch subsections 7 by horizontal lines of weakening 4 and 9 and vertical lines of weakening 3 and 10. The lines of weakening are preferably microperfed. However, the lines of weakening can also consists of partial diecuts, score lines, cut-and-ties or die cutting a facestock sheet of a multi-layer construction. The easel pad sheet can be drawnon without regard for the lines of weakening and the subsections they define as shown by the indicia 5. Further, the dimension of the easel pad and the easel pad sheets can be modified to work with most standard size papers including legal and European paper sizes such as A4. Further each subsection 7 can contain preprinted indicia on it so that the easel pad is setup for use in specific situations such as brainstorms, planning and categorizing. Further the easel pad may contain orientation markings to identify each subsection's location on the sheet and within the easel pad stack of sheets. Further, the orientation markings may be used by a software program to assemble the individual scanned subsections into a composite electronic image accurately representing the analog image created on the easel pad sheet 8.

A single easel pad sheet removed from the easel pad of the preferred embodiment is shown in FIG. 3. The single easel pad sheet and the partial image 30 written on the easel pad sheet is divided into nine subsections by vertical and horizontal lines of weakening.

Separated subsections 40 of the preferred embodiment are shown in FIG. 4. The subsections, including subsection 40, are separated along and defined by the lines of weakening. The partial image 30 is separated into subsections as a consequence of the subsection it is written on as shown in FIG. 4.

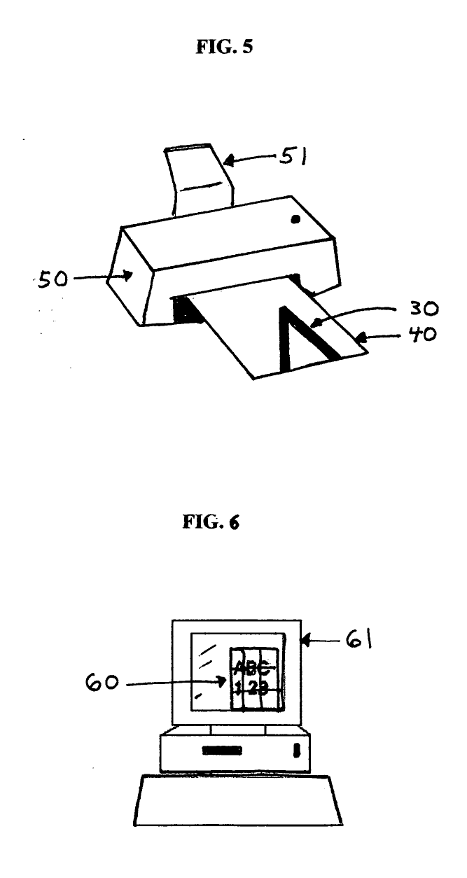

The separated subsections shown in FIG. 4 are then loaded and scanned by a desktop scanner 50 as shown in FIG. 5. An example of a typical desktop scanner is the Hewlett Packard document scanner Mfg. Part #: C9926A designed to automatically scan up to 24 pages at a time of 8.5 by 11 inch sheets of paper. FIG. 5 shows one of the nine subsections 40 is shown being scanned by the scanner 50 after loading the separated subsection 40 into the paper tray 51 the scanner scans the page 40 including the partial image 30.

The scanned digital images from the scanner 51 are then transmitted to the personal computer FIG. 6 by a physical connection or a wireless connection. The digital images are preferably scanned at a resolution of 72 dpi to 600 dpi. A computer software program then assembles the individually scanned images into an electronic composite image 60 and displays it as shown on the computer screen 61. A nonlimiting example of a personal computer is a Dell Dimension 2400 desktop computer available from Dell. A nonlimiting example of a software program to assemble the scanned subsections into a electronic composite image is Adobe Photoshop 6.0 available from Adobe, Inc. Further the assembled composite electronic image can be translated into machine readable text by a optical character recognition programs. Thus, the document may be easily distributed electronically by email, shared networks, CDROM or similar electronic storage devices. A nonlimiting example of a optical character recognition program is Omnipage Pro 14 OCR software available from Scansoft Inc.

In another alternative embodiment the vertical and horizontal lines shown in FIG. 1 can be used to fold the easel pad sheet into a 8.5 by 11 inch folded assembly for storage in a file folder, binder or the like. Further the folded assembly can be hole punched for storage in a 3 ring binder or the easel pad sheets can come with holes pre-punched in the sheet such that when the easel pad sheet is folded up along the lines of weakening the holes line up to form 3 apertures for securing the folded easel pad sheet into a 3 ring binder.

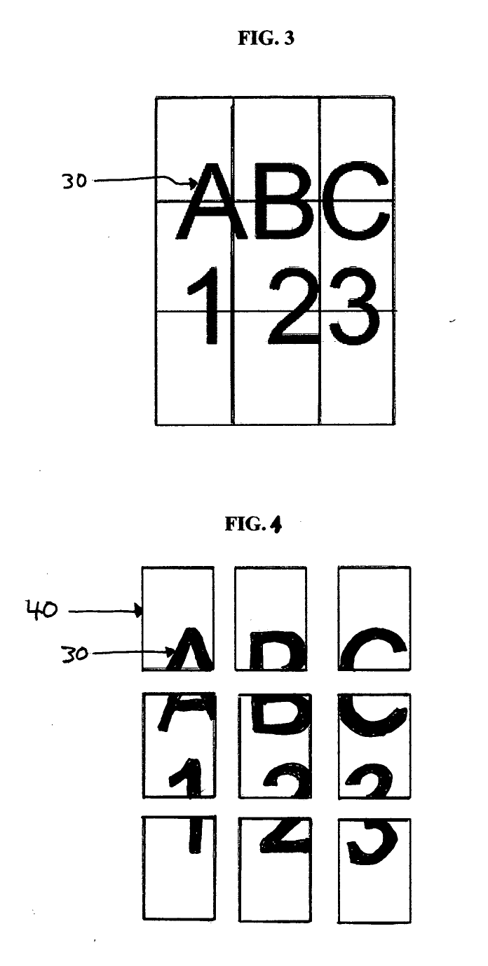

In an alternative embodiment shown in FIG. 2, a 28.5 by 33 inch erasable 8 mil polyester plastic sheet 20 is attached to the bound end 1 and repositionable to the front or back of the easel pad by flipping the plastic sheet from the front to the back or from the back to the front. The polyester plastic sheet 20 has contact clarity to allow the indicia 5 written on the easel pad sheet 8, even though it is under the polyester plastic sheet 20, to be viewed through the plastic sheet 20 as shown in FIG. 2. Indicia 21 can be erasably written on the plastic sheet 20 by whiteboard markers and the like. Indicia 21 can then be erased by a whiteboard eraser, mild solvents or cleaning solutions. Other nonlimiting examples of material the plastic sheet 20 can be made out of are: polypropylene, polyester, polyethylene, polyimide and vinyl films. Further, the plastic sheet 20 may be of any color including white. Further, the plastic sheet may be of any clarity including opaque. Further, the plastic sheet 20 may be from 2 mil to 40 mil in thickness.

In another alternative embodiment the individual subsections shown in FIG. 4 can be loaded in to a personal shredder. A nonlimiting example of a personal shredder is the Fellowes PS60c-2 shredder.

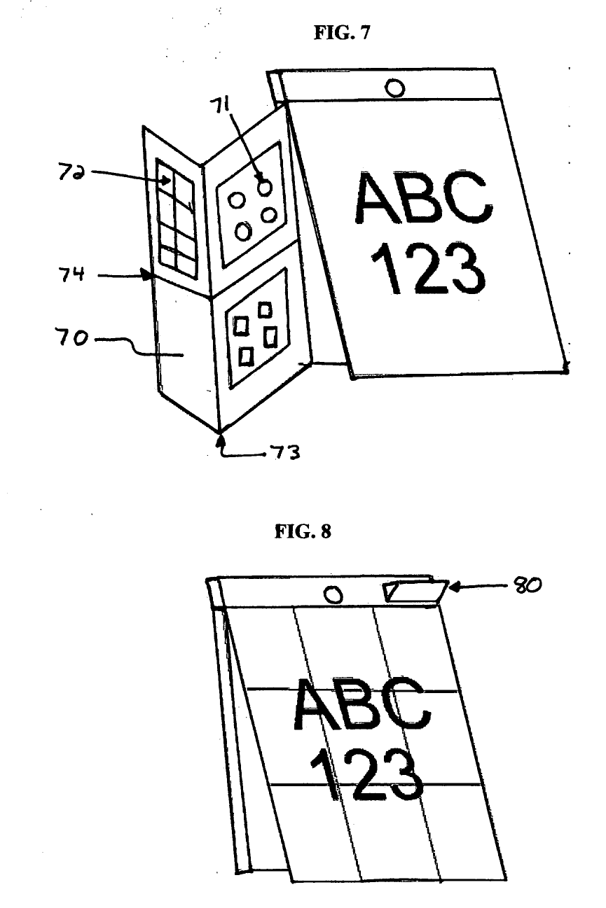

In another alternative embodiment shown in FIG. 7 a 25.5 by 33 inch label sheet is attached to the easel pad. A nonlimiting example of label material is Fasson® Standard Laser-Rite/AT1/50# MF available from Fasson, Inc. The label sheet is preferably attached to the backing and folds out to enable removal of individual label sheet subsections 70 defined by lines of weakening 73 and 74. Nonlimiting examples of lines of weakening are microperfs, partial die cuts, and cut-and-ties. Each subsection 70 is preferably 8.5 by 11 inches whereby each subsection 70 can be removed from the label sheet and printed on by a laser or inkjet printer. The subsections may further contain specific die cut shapes 71 and may be preprinted with indicia or blank for printing on later by a desktop printer. The die cut shape 72 may also be used to adhere individual easel pad sheets to a substrate instead of using masking tape or the like.

In an alternative embodiment shown in FIG. 8, a writing instrument holder 80 is attached to the bound edge of the easel pad. The writing instrument holder 80 is preferably made of polypropylene plastic and attached to the easel pad using a pressure sensitive adhesive. However, the writing instrument holder may be constructed with any type of plastic, paper or cardboard. The preferred dimensions of the writing instrument holder dimensions are 8 inches wide by 2 inches tall by 2 inches deep.

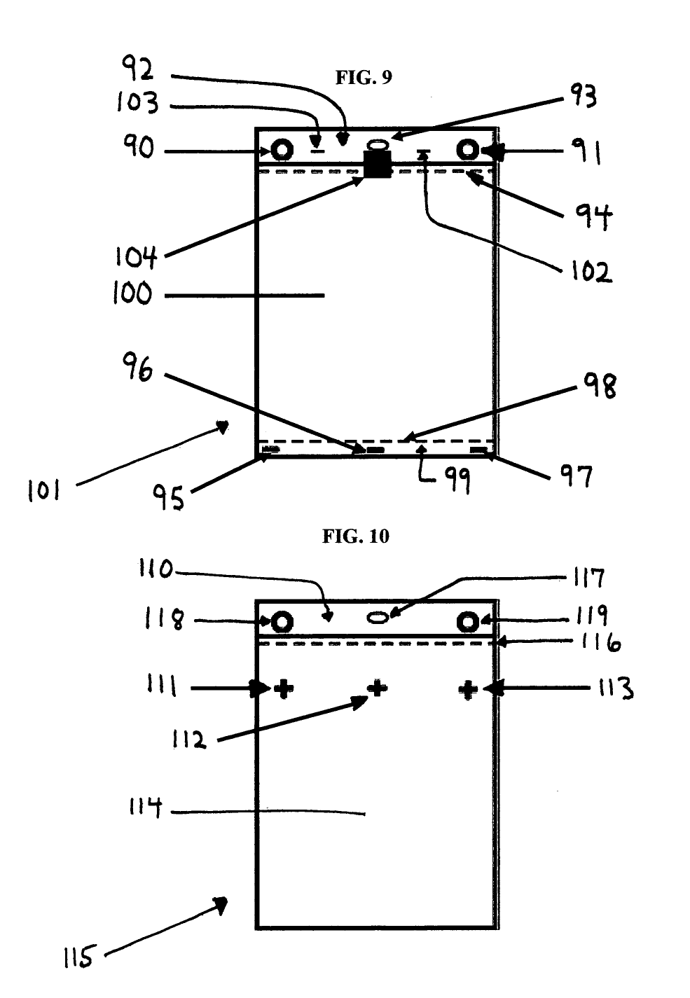

In an alternative embodiment shown in FIG. 9 twenty five 27 by 34 inch easel pad sheets are bound on the top end 92 by staples 102 and 103 and bound on the bottom end 99 by staples 95, 96 and 97. Additional non limiting means of binding the top and bottom edge are adhesives, clips and clamps. Each easel pad sheet 100 contains lines of weakening 94 and 98 to release the easel pad sheets 100 from the easel pad 101. Non limiting examples of lines of weakening are microperfs, die cuts and score lines. The top bound edge has aperatures 90, 91 and 93 to facilitate mounting of the easel pad to a hook or finger on a wall or substrate. Other non limiting means of attachment are Velcro, adhesive, nails and thumb tacks.

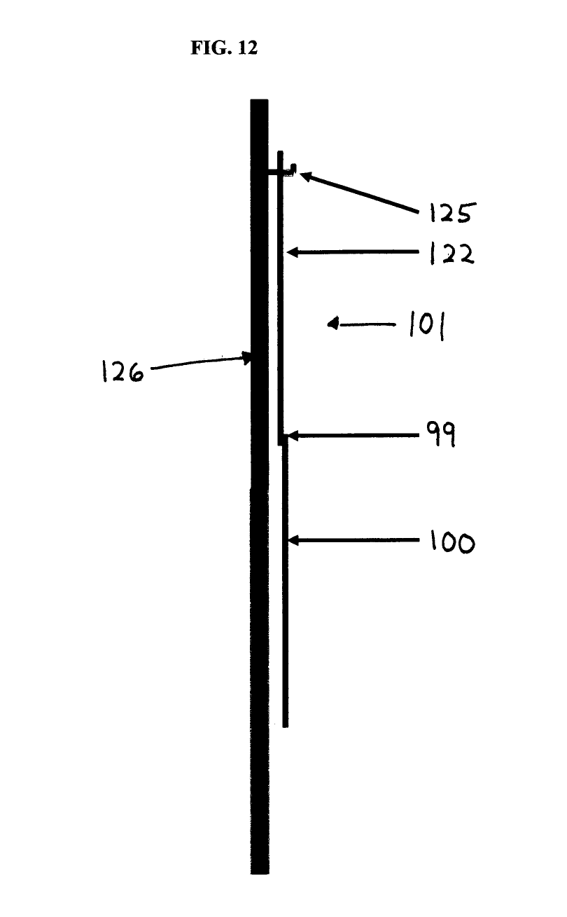

FIG. 11 shows the embodiment in FIG. 9 with an easel pad sheet 100 released from the top bound edge 92 along line of weakening 94 releasing the paper edge 123 and allowing it to hang down exposing a new easel pad sheet 122 for writing or drawing on. The hanging easel pad sheet 100 can also be released from the easel pad along the line of weakening at the bottom of the easel pad. Any number of easel pad sheets can be released from the top bound edge 92 along the line of weakening 94 to expose unmarked easel pad sheets. A clip 104 is attached to the bound end 92 to re-attach the hanging sheets back into their original position if desired. The easel pad 101 is preferrably attached to a wall or substrate. FIG. 12 shows a wall 126 with hooks 125 inserted into the aperature's 90 and 91 in the easel pad 101. The easel pad 101 has an easel pad sheet 100 released along the line of weakening and hanging down and attached by the bottom bound end 99 exposing a new easel pad sheet 122 for writing and drawing on.

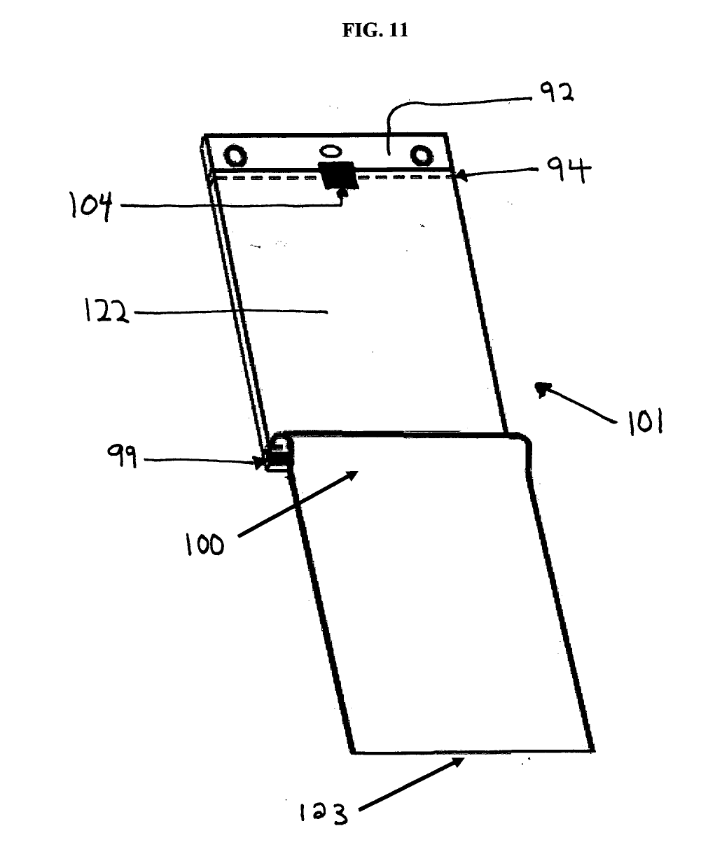

In an alternative embodiment shown in FIG. 10 fifty 27 by 34 inch easel pad sheets are bound on the top end 110. Each easel pad sheet contains a line of weakening 116 along the top of the easel pad sheet in order to facilitate releasing each easel pad sheet 114 from the easel pad 115. Non limiting examples of lines of weakening are microperfs, die cuts and score lines. Each easel pad sheet also contain lines of weakening 111, 112 and 113 in the shape of a cross. Other nonlimiting line of weakening shapes or patterns are circles, squares, diamonds or the like. The lines of weakening 111, 112 and 113 are placed on the easel pad sheet 114 such that when the easel pad sheet 114 is flipped back over the top of the bound end 110 and behind the easel pad 114 the lines of weakening align with the aperatures 117, 118 and 119. Once the lines of weakening 111, 112 and 113 and the aperatures 117, 118 and 119 are aligned a hook or finger mounted on a substrate can penetrate through a easel pad sheet that has been flipped over the bound end 110 and is now behind the easel pad 115 still attached to the bound end 110.

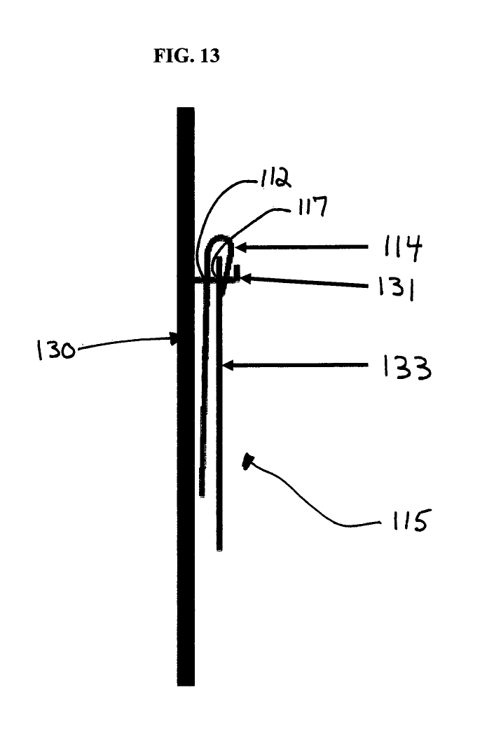

FIG. 13 shows the easel pad 115 attached to a wall 130 by a hook 131 inserted through the lines of weakening 112 in the form of a cross and then into the aperature 117 holding the easel pad 115 to the wall 130. The easel pad sheet 114 is flipped over the top of the top bound edge and behind the easel pad 115 exposing a new easel pad sheet 133 for writing or drawing on. The lines of weakening are 111, 112 and 113 are placed on the easel pad sheet in a position that allows them to line up with the aperatures 117, 118 and 119 when the easel pad sheet 114 is flipped over and behind the easel pad as shown in FIG. 13.

Another alternative embodiment includes a method for dividing an easel pad sheet into a 2 to 9 subsections. Each subsection can then be removed from the sheet along lines of weakening and then scanned into a sheet fed desktop scanner, copied on a copier, printed on with a desktop printer or shredded in a sheet fed shredder. The scanned sheets can then be distributed electronically or reassembled into a composite image for distribution or optical character recognition.

Another alternative embodiment includes a method for erasably writing on an easel pad by attaching a repositionable plastic sheet to the easel pad. The plastic sheet is then flipped over the easel pad to provide an erasable writing surface or it can be flipped over the back of the flip chart so that it is out of the way.

Another alternative embodiment includes a method for attaching a sheet of stickers to an easel pad. The stickers can be pre-printed or the stickers can be subdivided into a 2 to 9 subsections along lines of weakening and then printed on by a sheet fed desktop printer or copier.

Another alternative embodiment includes a method for writing on an easel pad mounted or attached to a wall or substrate. Each flip chart sheet is bound on the top and bottom edge so that the top of the sheet can be released along a line of weakening, whereby it hangs down by the bottom bound end and out of the way exposing a new clean easel sheet. The hanging sheet can then be released from the bottom bound end along a line of weakening.

While a preferred form of the invention has been shown in the drawings and described, since variations in the preferred form will be apparent to those skilled in the invention should not be construed as limited to the specific form shown and described, but instead is as set forth in the following claims.

I claim:

1. A stack of sheets comprising:
a plurality of paper sheets with dimensions of at least 25.5 by 33 inches each having a top surface which is flat, a bottom surface which is flat, a free end, two sides and a bound end; and
a backing for supporting the paper sheets; and
a means for securing the paper sheets and the backing together to form the bound end; and
a horizontal line of weakening which enables the paper sheet to be removed from the bound end; and
nine 8.5 by 11 inch subsections defined by lines of weakening; and
whereby each 8.5 by 11 inch subsection can be removed from the paper sheet and loaded into a sheet fed machine.

2. A stack of sheets according to claim 1, further comprising a sheet of stickers bound to the stack of sheets.

3. A stack of sheets according to claim 1, wherein the bound end contains an aperture located in the center of the bound end.

4. A stack of sheets according to claim 1, wherein the subsections are marked to identify their location and orientation on the paper sheet.

5. A stack of sheets according to claim 1, wherein the subsections are preprinted with indicia.

6. A stack of sheets according to claim 1, further comprising a writing instrument holder attached to the bound end.

7. A stack of sheets according to claim 1, further comprising a plastic sheet which is attached to the bound end whereby the plastic sheet can be overlayed on top of the paper sheet for writing on the plastic sheet with erasable markers in order to preserve the paper sheets free from markings.

8. A stack of sheets comprising:
a plurality of paper sheets each having a top surface which is flat, a bottom surface which is flat, a free end, free sides and a bound end; and
a backing means for support the paper sheets; and
a means for securing the paper sheets and the backing together to form the bound end; and
a plastic sheet attached to the bound end whereby the plastic sheet provides an erasable marking surface.

9. A stack of sheets according to claim 9, wherein the plastic sheet has contact clarity when placed in proximity to the paper sheet whereby the writing underneath the plastic sheet can still be viewed.

10. A stack of sheets according to claim 9, further comprising a horizontal line of weakening to enable the paper sheet to be removed from the bound end.

11. A stack of sheets according to claim 10, wherein the bound end contains an aperture located in the center of the bound end for hanging the stack of sheets on a substrate.

12. A stack of sheets according to claim 9, wherein the paper sheets are divided into subsections by lines of weakening whereby the subsection is removed and loaded into a sheet fed machine.

13. A stack of sheets according to claim 9, further comprising a sticker sheet which is attached to the stack of sheets.

14. A stack of sheets according to claim 9, wherein the plastic sheet is a 2 to 20 mil polyester film.

15. A stack of sheets comprising:
a plurality of paper sheets with each having a top surface which is flat, a bottom surface which is flat, a free end, two sides and a bound end; and
a backing means for supporting the paper sheets; and
a means for securing the paper sheets and the backing together to form the bound end; and
a sticker sheet attached to the stack of sheets.

16. A stack of sheets according to claim 16, wherein the sticker sheet contains diecut shapes for adhering the paper sheet to a substrate after it is removed from the stack of sheets.

17. A stack of sheets according to claim 16, wherein the sticker sheet is divided into 8.5 by 11 inch subsections whereby each subsection can be fed into a sheet fed machine for printing.

18. A stack of sheets comprising:
a plurality of paper sheets each having a top surface which is flat, a bottom surface which is flat, a free end, free sides and a bound end; and
a backing means for support the paper sheets; and
a means for securing the paper sheets and the backing together to form the bound end; and
a horizontal line of weakening which enables the paper sheet to be removed from the bound end; and
a combination of horizontal and vertical lines of weakening whereby each paper sheet can conveniently be folded upon the lines of weakening for storage and handling.

19. A stack of sheets comprising:
a plurality of paper sheets each having a top surface which is flat, a bottom surface which is flat, free sides, a bound top end; and
a horizontal line of weakening which enables the paper sheet to be removed from the top bound end; and
a bound bottom end for attaching the paper sheets to the stack of sheets whereby the paper sheet is attached to the bottom end even after the paper sheet is released from the top bound end.

20. A stack of sheets according to claim 19, further comprising a line of weakening along the bottom bound end.

21. A stack of sheets according to claim 19, further comprising a binding mechanism on the top bound end for releasably attaching paper sheets.

22. A method of subdividing a easel pad into a plurality of subsections for feeding into a sheet fed machine, which comprises:
a) Dividing a easel pad sheet into a plurality of subsections; and
b) Removing a subsection of the sheet of paper along lines of weakening; and
c) Feeding the subsection into a sheet fed machine.

23. A method of erasably writing on a easel pad, which comprises:
a) Attaching a repositionable plastic sheet to a easel pad; and
b) Positioning the plastic sheet on top of a easel pad sheet; and
c) Writing on the plastic sheet with erasable markers.

24. A method of writing on an easel pad mounted to a substate, which comprises:
a) Binding an easel pad on the top and bottom ends; and
b) Releasing the top of an easel paper sheet along a line of weakening; and
c) Exposing a new paper sheet by having the paper sheet hang down by the bottom bound edge of the easel pad.

25. A method of adhering a easel pad sheet of paper to a substrate, which comprises:
a) Attaching a sheet of stickers to a easel pad; and
b) Removing die cut stickers from the sheet of stickers; and
c) Removing a easel pad sheet from the easel pad; and
d) Attaching the die cut stickers to the easel pad sheet and a substrate, whereby the easel pad sheet is adhered to a substrate.
